(19) United States
(12) Patent Application Publication
(10) Pub. No.: US 2012/0312102 A1
(43) Pub. Date: Dec. 13, 2012

(54) FORCE SENSING DEVICE AND METHODS FOR PREPARING AND USES THEREOF

(75) Inventors: Noe T. alvarez, Houston, TX (US); Jeffrey L. Bahr, The Woodlands, TX (US); Manuel Quevedo-Lopez, Richardson, TX (US)

(73) Assignees: The University of Texas System, Austin, TX (US); Nanocomposites Inc., The Woodlands, TX (US)

(21) Appl. No.: 13/489,006

(22) Filed: Jun. 5, 2012

Related U.S. Application Data
(60) Provisional application No. 61/494,378, filed on Jun. 7, 2011.
(60) Provisional application No. 61/546,767, filed on Oct. 13, 2011.
(60) Provisional application No. 61/615,392, filed on Mar. 26, 2012.

(51) Int. Cl. H01B 1/20; H01B 1/24; H01B 1/22; G01L 5/16

(52) U.S. Cl. 73/862.041; 252/500; 252/511; 252/503; 252/514

(57) ABSTRACT

Disclosed are polymer nanocomposites that can serve as piezoresistive compositions. Also disclosed are sensors comprising the disclosed piezoresistive compositions and methods for using the disclosed sensors.

### PRIORITY

This application claims priority to U.S. Provisional Application 61/494,378, filed Jun. 7, 2011, to U.S. Provisional Application 61/546,767, filed Oct. 13, 2011, and to U.S. Provisional Application 61/615,392, filed Mar. 26, 2012, all of which are incorporated herein by reference in their entirety.

### GOVERNMENT SUPPORT

This disclosure was made with government support under Grant Number 1009734 awarded by the National Science Foundation. The United States Government has certain rights in the disclosure.

### FIELD

Disclosed are polymer nanocomposite materials that can serve as piezoresistive compositions. Also disclosed are sensors comprising the disclosed polymer nanocomposite materials and methods for using the disclosed sensors.

### BACKGROUND

Signals are important to the functioning of modern technology. Signals can have a number of purposes; a warning that an apparatus is malfunctioning, that a pre-determined time period has elapsed, that a process has run its due course, etc. Of particular importance are remote sensing devices. These devices serve to alert the user that a circumstance has occurred, for example, the warning lights on an automobile dashboard can alert the driver that re-fueling is necessary or that there is a malfunction in the engine. The alerts that signals provide are all dependent on the type and configuration of the sensor; and especially to the sensor's selectivity and sensitivity.

Force or pressure (force per area) sensors have widespread utility. Sensors utilizing microelectro-mechanical systems technology (MEMS) have been developed. One mechanism by which these force sensors operate is by detecting changes in the electrical behavior of a material based upon the physical deformation of the material, wherein the deformation is induced by an external, applied force. An example is a force acting upon a membrane or diaphragm comprising a “piezoresistive material.” A piezoresistive material is compound or composition that undergoes a change in its electrical properties, i.e., resistivity, when physically deformed. This deformation can be caused by the application of an external force, such as by impingement of an object to the material surface, or by a change in hydrostatic or differential pressure. Therefore, reproducible changes in the electrical properties of a piezoresistive material can be used as a method for detecting changes in pressure, force, or strain.

There is a long felt need in the art for sensors that can be adapted to a wide range of usages, from durable bulk sensing with low sensitivity to micro-sensors having a high degree of sensitivity. There is also a long felt need for systems that comprise adaptable sensors which can be configured to any specification desirable by the users with the corresponding degree of required sensitivity.

### BRIEF DESCRIPTION OF THE FIGURES

FIG. 1A depicts one embodiment of the disclosed sensors wherein two electrodes 102 and 103 are disposed on opposite sides of a disclosed piezoresistive composition 101. FIG. 1B depicts the change in the thickness of composition 101 due to a downward force acting on system 100 thereby changing the resistivity of composition 101.

FIG. 2 depicts one embodiment of the disclosed sensors wherein two electrodes 202 and 203 are disposed on the same side of a disclosed piezoresistive composition 201.

FIG. 3 depicts an apparatus 300 configured to measure the piezoresistivity of a disclosed piezoresistive composition 304, utilizing a plunger 301 to apply a controlled force.

FIG. 4 depicts a 3×3 array of Schottky diodes indicating a first center contact 401 and a second outside contact 402.

FIG. 5 depicts a larger array of the Schottky diodes showing center contacts 502 and second contacts 501.

FIG. 6 depicts an embodiment of a disclosed sensor, 600, comprising an array of Schottky diodes 603, a piezoresistive composition 601, and supporting layers 602 and 605.

FIG. 7 is a graph of the change in electrical resistance measured by a disclosed sensor according to Example 1, wherein increasing force applied to a disclosed piezoresistive composition results in decreasing electrical resistance.

FIG. 8 graphically represents a series of exponential decays in the resistance measured by a disclosed sensor upon application of various amounts of an applied force.

FIG. 9 depicts an embodiment of a disclosed sensor, 900, configured for use in an apparatus configured to read Braille.

FIG. 10 depicts use of a disclosed sensor, 1002, configured to measure the force applied by a seal 1004 against a sealing surface 1001.

FIGS. 11A and 11B depicts a cross-section view of one embodiment of the disclosed sensors before and after activation wherein the sensors are configured for use with a wellbore packer.

FIG. 12 depicts the change in electrical resistance of the embodiment described in Example 2.

FIG. 13 depicts a cross-section view of the system described in Example 2.

FIG. 14 depicts an embodiment of the disclosed sensors, 1400, comprising an array of electrodes 1401 in contact with a disclosed piezoresistive composition 1402.

### DETAILED DESCRIPTION

The materials, compounds, compositions, articles, and methods described herein may be understood more readily by reference to the following detailed description of specific aspects of the disclosed subject matter and the Examples included therein. Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### GENERAL DEFINITIONS

In this specification and in the claims that follow, reference will be made to a number of terms, which shall be defined to have the following meanings:

All percentages, ratios and proportions herein are by weight, unless otherwise specified. All temperatures are in degrees Celsius (° C.) unless otherwise specified.

A weight percent of a component, unless specifically stated to the contrary, is based on the total weight of the formulation or composition in which the component is included.

“Admixture” or “blend” is generally used herein means a physical combination of two or more different components

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

The term “piezoresistive” means the property of a material, whether a single compound or a mixture of compounds, wherein physical deformation of the material results in a change in the electrical properties of the material, for example, the electrical resistivity, or the electrical resistance in a circuit, independent of the cause of the physical deformation. Non-limiting examples of forces which can cause a deformation in a material resulting in a change in electrical properties includes stress, strain, pressure, temperature, or contact with various fluids and/or gases.

The term “resistivity” means an intrinsic property of a material, related to the conduction of electricity, or passage of an electrical current. For example, the disclosed piezoresistive compositions can have a particular resistivity as described herein. The disclosed compositions before being acted upon by a force will have an “initial resistivity.” After being acted upon by a force and the force is subsequently removed the composition will have a “recovered resistivity.” The recovered resistivity can have any value equal to, less than, or greater than the initial resistivity.

The term “resistance” means an extrinsic property of a particular circuit, as in Ohm's law: E=iR where E is the potential difference across a conductor, i is the current through the conductor, and R is the resistance of the circuit. For example, as described herein, a disclosed piezoresistive composition, possessing a certain resistivity, can be part of a circuit comprising the piezoresistive composition and at least two electrodes. The circuit thus comprised will have a certain resistance.

The term “piezoresistive membrane” means a membrane comprising at least one piezoresistive composition.

The term “piezoresistive composition” means a composition whose electrical properties are affected by an applied force or deformation.

The term “nanocomposite” means a material comprising at least one component having at least one dimension less than about 100 nanometers (nm). For the disclosed membranes, the inclusion of the prefix “nano” in connection with a dimension relates to at least one dimension less than about 100 nm, for example, nanorods are materials in the shape or form of rods having at least one dimension less than 100 nm.

The term “roughness” as applied to the surfaces described herein means a surface that is uneven, irregular, coarse in texture, broken by prominences, and others. Surface roughness depends on the relative scale of measurement and has statistical implications since it can take into consideration factors such as sample size and sampling interval. As it applies to the present disclosure, a center-line average roughness Rₐ which is also known as arithmetic average defined by the following formula:

$${R}_{a} = \frac{1}{L} {\int }_{0}^{L} \vert z ( x ) \vert d x$$

wherein L is the evaluation length, z the height and x the distance along the measurement. (See, for example, Thomas, T. R. “Rough Surfaces” 2^{nd} ed., Imperial College Press, London 1999)

The term “in-plane resistivity” means a change or variation in resistivity along the “X” and “Y” axis on a single surface of a composition have at least two surfaces.

The term “through-plane resistivity” means a change or variation in resistivity measured between top and bottom surfaces of a composition having at least two, i.e., between a first surface of a composition and the second surface of a disclosed composition.

The term “translation into an audible form” means the conversion of a specific electrical resistance into a corresponding sound. For example, a local change in electrical resistance that occurs can be collected and converted to one or more digital forms, i.e., data which can then be used via known software to convert these data to data reproducible in the form of an audio signal.

The meaning of “percolation threshold” as used herein is well understood by the person of skill in the art. In summary, the percolation threshold is a mathematical term related to percolation theory, which is the formation of long-range connectivity in random systems. Below the threshold a giant connected component does not exist while above it, there exists a giant component of the order of system size.

The term “force threshold” means the minimum applied force required to cause a change in resistance of at least about one order of magnitude. For example, a disclosed sensor with the force threshold of 10 N, if the zero force resistance is 10 MOhm, the resistance at an applied force of 1, 2, 3, 4, 5, 6 etc. N is greater than 1 MOhm, while at an applied force of 12 N the resistance is less than 1 MOhm.

The term “lateral resolution” means the ability to distinguish how closely two points wherein forces have been applied are located and to determine with accuracy their proximity. As such, the greater the lateral resolution the higher the accuracy in determining the exact location at which a force is applied to one or more locations on a surface. Because of the ability of the disclosed embodiments to provide the formulator with increased lateral resolution, there is afford a greater ability for the formulator to geographically locate areas where outside forces are applied.

Disclosed herein are systems, sensors and piezoresistive materials that can provide accurate, tunable, and adaptable remote sensing of force. The disclosed pieozoresistive compositions can be adapted by the formulator to have increased or decreased sensitivity. For example, if the sensor is adapted to differentiate between large and small forces acting upon the system, then the piezoresistive material can be fabricated in a manner that small nascent forces due to the environment or forces below a certain level will be below the detection threshold. In a like manner, when small forces are to be detected, the composition can be adapted to measure micro changes in the composition due to weak forces.

The disclosed systems can be adapted to detect the presence of force per se on the system or the system can be adapted to indicate the precise location where the force has been applied and the amount thereof. The disclosed sensor arrays can be configured to any sensitivity or range of sensitivities. In fact, a particular array can comprise differential sensitivity. For example, the array can comprise a piezoresistive composition wherein the intrinsic resistivity of the composition varies from location to location of the membrane or can have a continuous differential resistivity along the membrane.

The membranes that comprise the piezoresistive compositions can be configured in any manner desired by the user, i.e., stretched across an opening, configured proximally to a sealing surface, or in register with one or more sealing surfaces.

The disclosed membranes, piezoresistive compositions, sensors and systems disclosed herein are not restricted to the following disclosure by way of limitation.

### Systems

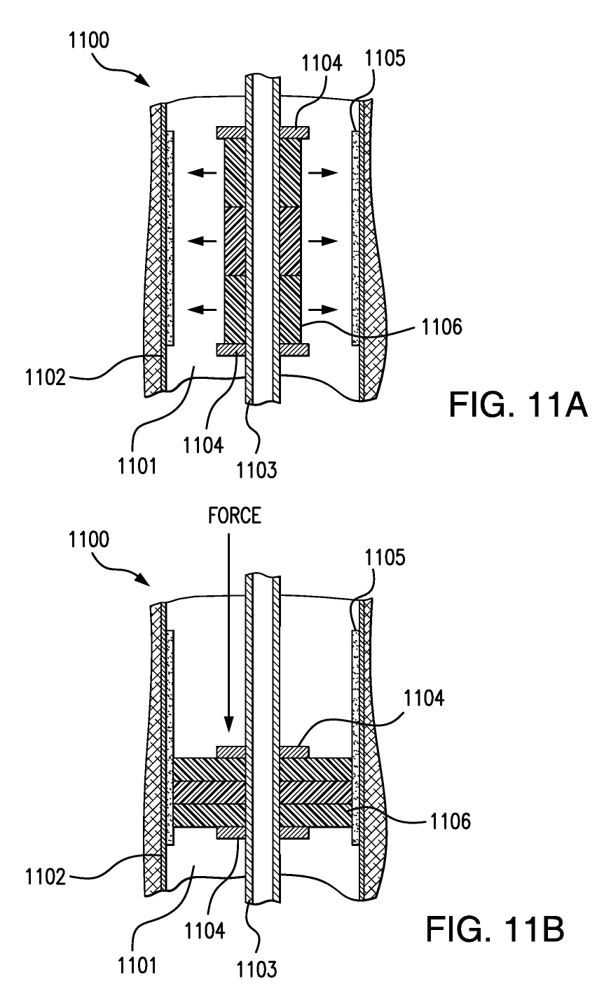

Disclosed herein are systems for measuring or detecting an applied force. The disclosed systems comprise as least one of the herein disclosed sensors. The disclosed systems are capable of measuring or detecting an applied force in a wide variety of uses, for example, a force that is applied against a sealing surface by a sealing element (seal). For example, as illustrated in FIG. 11A and FIG. 11B, sealing elements 1106 impinge upon a sealing surface 1102 with a certain force, which can be detected by sensor 1105.

In one embodiment, the applied force to be detected or measured is a sealing force caused by deformation of a seal as disclosed herein. In one iteration of this embodiment, the deformation is caused by a mechanism or an apparatus configured to engage a seal. In another iteration, the deformation is caused by an external force, for example, by a gas, liquid, solid or mixture thereof contacting the seal. In one example, a seal is deformed in a manner that causes the seal to swell vertically, horizontally or both, thereby causing the seal which can comprise a piezoresistive material, to make contact with a sealing surface.

In one aspect the disclosed sensors provide a means for verifying engagement, activation or setting of a seal wherein the engagement, activation, or setting of the seal is caused at least in part by an external mechanism or force.

In another aspect the disclosed sensors provide a means for verifying engagement, activation, or setting of a seal wherein the engagement, activation, or setting of the seal is caused at least in part by swelling of the seal.

The disclosed systems can be used in detecting the engagement of a seal, for example, wherein the seal functions as a blow-out-preventer. In another example the seal functions as a packer. In a further example the seal is a packer consisting of one or more packer elements.

In a further aspect of the disclosed systems the sealing surface can be the inner wall of a wellbore casing or the wall of an open hole wellbore.

In one aspect of the disclosed systems the herein disclosed sensor and be configured to be adjacent to a seal as disclosed herein. Alternatively, the sensor can be configured to be adjacent to or in proximity to a sealing surface.

The disclosed systems can further comprise a means for electrical communication between the system and the user. The user, however, is not constrained to use any one type of electrical communication or the use any particular means for identifying that a force has been detected by the disclosed systems.

In one aspect, the means for communication that a force has been applied to the sensor can be in the form of a signal to the user. In one embodiment the signal can be an audible signal, for example, an audible alarm. Non-limiting examples of audible signals include buzzers, bells, a klaxon, a musical note or a series of increasing or decreasing sounds that signal the magnitude of the force or the type of force being applied. The user is not restricted to any type or combination of audible signals.

In another embodiment of this aspect, the signal can be a visual signal. Non-limiting examples of visual signals include a light, as series of lights wherein a single light flashes at varying intervals, the light changes color, hue or brightness or flash interval depending upon the magnitude of the applied force. The user is not restricted to any type or combination of visible signals.

In an aspect wherein the disclosed system is deployed remote from the user, for example, when the system is used downhole as in a drilling operation, the means for communicating whether a force has been applied to a sensor can be by any means suitable, such as telemetry means known in the art, electromagnetic induction, fiber optic, electrical wire or cable, or wireless transmission.

In one embodiment, the disclosed system further comprises associated electronics and software to receive electrical signals from a disclosed sensor, to optionally perform certain manipulations of said signals, and to optionally transmit the original or manipulated signals in the form of data to a local or remote location.

Other non-limiting examples of uses the disclosed systems are described or illustrated herein.

### Sensors

The disclosed sensors comprise:

a) a piezoresistive composition, comprising:
i) one or more polymers; and
ii) one or more conductive elements dispersed therein; and

b) at least two electrodes in electrical communication with the composition;

wherein the sensor is configured to receive an applied force against at least one surface. As described herein below, the conductive elements can be of different composition, shape, or source, or the composition can be homogeneous with regards to the conductive elements, i.e., having the same type dispersed therein.

In one aspect, the sensors comprise a piezoresistive composition having a first side and a second side wherein each side, together or independently, are in electrical communication with a means for registering the change in resistivity of the piezoresistive composition. For example, prior to use the piezoresistive composition has an intrinsic resistivity. This resistivity is manifested in an amount of measurable resistance that is observed when electrical current flows from one electrode connected to the composition to another electrode connected to the composition. When deformed, for example, by a force acting upon the composition, the resistivity change can be measured as a change in resistance to the current flow between the two electrodes. This change in resistance can be communicated to the user and therefore provides notification that a deformation in the composition has occurred.

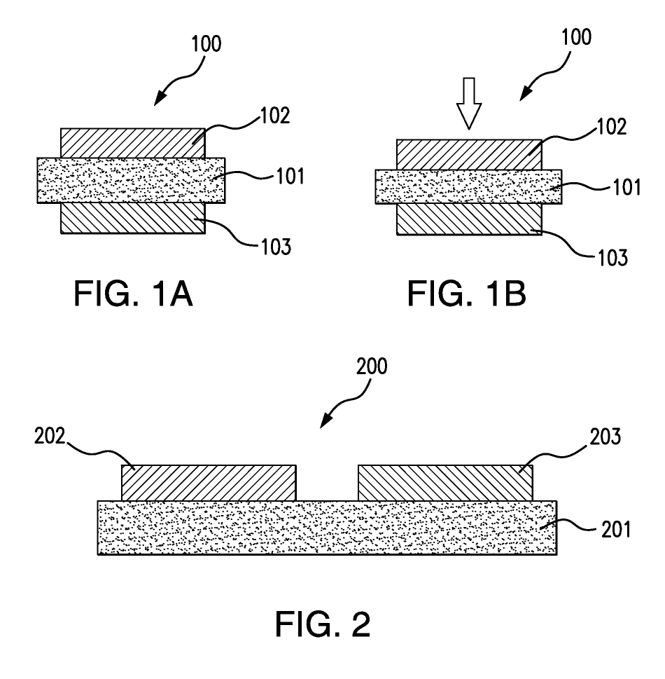

The manner in which the disclosed sensors function is exemplified in general in FIGS. 1A and 1B. FIG. 1A, not drawn to relative scale, depicts sensor 100. A piezoresistive composition 101 is in contact with a first electrode 102 and a second electrode which are in electrical communication (not shown) with a user. A potential difference, E, is applied thereto, i.e., a voltage is applied across the two electrodes such that a current, i, flows from one electrode to the other through piezoresistive composition 101. The amount of current that can pass through piezoresistive composition 101 is dependent upon the materials that comprise the composition 101.

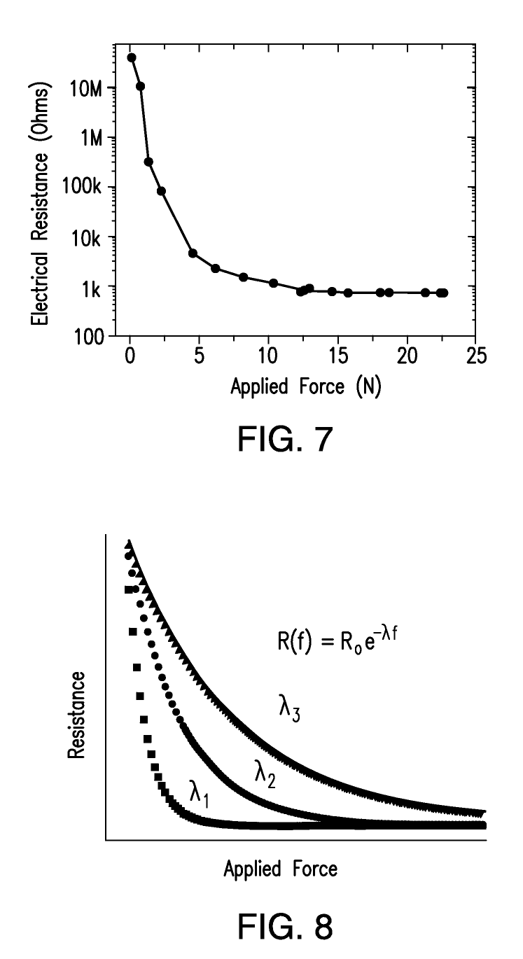

In a non-limiting example as depicted in FIG. 1B, a downward force is applied to sensor 100 thereby compressing piezoresistive composition 101. This deformation causes a change in the resistivity of the composition. This change in resistivity can be measure in any manner chosen by the user. For example, the observed change in current flow, Δi, can be measured. If configured in another manner, the change in potential difference, ΔE, across the electrodes can be measure. Alternatively the change in resistance to current flow can be determined. FIG. 7 provides an example of how the change in resistivity of a piezoresistive composition, as exemplified in Example 1, can be correlated to the change in electrical resistance.

In another aspect, as depicted in FIG. 2, only one side of the piezoresistive composition is in electrical communication with a means for communicating that a force has been applied to the sensor, i.e., piezoresistive composition surface.

In another aspect, the sensor is encapsulated is a suitable material so as to mitigate or to prevent the influence of ambient environmental elements, such as moisture or any fluid, gas, solid, or combination thereof, on the function of the sensor.

In certain embodiments, the disclosed sensors can further comprise various insulating layers so as to prevent unwanted or stray current flow that may impact the sensor's function.

### Piezoresistive Composition

Disclosed herein are piezoresistive compositions. The disclosed compositions can be fabricated into any size or shape and adapted for use in any embodiment wherein an applied force is measured or detected. The following are non-limiting examples of the use and composition of the disclosed piezoresistive compositions.

In one aspect, the disclosed piezoresistive compositions can be fabricated in a manner such that the compositions can be used as piezoresistive membranes.

The disclosed compositions are piezoresistive polymer nanocomposites, comprising:

i) one or more polymers; and

ii) a plurality of conductive elements dispersed therein.

In one aspect, the disclosed piezoresistive polymer nanocomposites comprise:

i) one or more polymers;

ii) a plurality of conductive elements dispersed therein; and

iii) carbon black.

In a further aspect, the disclosed piezoresistive polymer nanocomposites comprise:

i) one or more polymers;

ii) a plurality of conductive elements dispersed therein; and

iii) one or more adjunct ingredients.

The polymers that can comprise the disclosed piezoresistive compositions can belong to one or more of the following non-limiting general classes of polymers, for example, thermoplastic, elastomeric, thermoplastic elastomeric, or thermoset polymers. The polymer can be in any form, for example, amorphous, semi-crystalline, crystalline, liquid crystalline, or a combination thereof.

The polymer can be prepared by any suitable means of polymerization known in the art, for example melt polycondensation, anionic polymerization, ring-opening polymerization, emulsion polymerization, radical polymerization, or metathesis polymerization. In one aspect, the membrane comprises an elastomeric polymer comprising one or more monomers chosen from ethylene, propylene, butadiene, isoprene, acrylonitrile, styrene, isobutylene, or fully or partially fluorinated or otherwise halogenated versions thereof, wherein the resulting polymer exhibits elastomeric or thermoplastic-elastomeric behavior upon crosslinking.

The following are non-limiting examples of elastomeric polymers suitable for use in preparing the disclosed piezoresistive compositions: natural rubber (NR), polyisoprene (IR), butyl rubber (IIR) and halogenated versions thereof, polybutadiene (BR), styrene-butadiene rubber (SBR), nitrile butadiene (NBR) and hydrogenated nitrile butadiene (HNBR), polychloroprene (CR), ethylene propylene rubbers (EPM and EPDM), silicone rubbers (SI, Q, VMQ), polydimethylsiloxane (PDMS) and derivatives, ethylene vinyl acetate (EVA), polymethylmethacrylate (PMMA), fluororoelastomers such as fluorinated ethylene propylene monomer rubber (FEPM, FKM), and perfluoroelastomers (FFKM) such as those made by copolymerization of monomers such as tetrafluoroethyelene and hexafluoropropylene.

The polymer can be a homopolymer comprising a single monomer, a copolymer comprising two monomers, or a terpolymer comprising three or more monomers. In a further aspect, the membrane can comprise an admixture of two or more polymers. The admixture can be formed by any suitable process selected by the formulator. Non-limiting examples include physical mixing, dynamic vulcanization, or other means known in the art. Suitable thermoplastic elastomers are exemplified by polyether block amides, styrenic block copolymers, polyolefin blends, thermoplastic copolyesters, and thermoplastic polyurethanes.

In one embodiment, when the disclosed piezoresistive composition comprises a copolymer, the different monomer units can be arranged in random fashion. In another embodiment of this aspect wherein the piezoresistive composition comprises a copolymer, the different monomer units can be arranged in block fashion, such as AABB di-block, or AABBCC tri-block, or alternating such as ABAB arrangement.

Further thermosetting polymers suitable for use in forming the disclosed piezoresistive compositions are exemplified by polyurethanes, vinyl esters, acrylates, epoxies, and other polymers derived from curing oligomeric or polymeric precursor compositions. The polymer composition can be formulated as one-part, two-part, or three-part composition depending on the components. The polymer comprising the disclosed membrane can be cured (set, crosslinked, or vulcanized) by ultra-violet or visible wavelength irradiation, electron beam irradiation, microwave irradiation, thermally cured, self-cured, vacuum cured, pressure cured, or any combination thereof.

The use of polymer nanocomposites as piezoresistive compositions, as disclosed herein, enables certain novel and useful properties to be achieved which have heretofore not been achievable with conventional materials. For example, in certain embodiments the disclosed piezoresistive composition fulfills at least one of the following characteristics:

I. The disclosed compositions are chemically compatible with the fluid or fluids and/or gas or gases that will come into contact with the piezoresistive composition, meaning that the piezoresistive composition will not suffer significant chemical attack nor loss of ability to function. Significant can mean a decrease of more than 50% in one or more of tensile strength, modulus, elongation at break. Examples of relevant fluids include, but are not limited to, hydrocarbon based fluids, hydrocarbon based fluids further comprising additives common to oilfield operations, drilling fluids, completion fluids, wellbore fluids, produced fluids, water, water based fluids further comprising additives common to oilfield operations, fuels, oil, lubricants, grease, silicone grease, and fluorocarbon grease. Examples of relevant gases include, but are not limited to, carbon dioxide, carbon monoxide, hydrogen sulfide, methane, ethane, propane, nitrogen, air, steam, and natural gas. The examples provided herein, while not limiting to the disclosure, are understood to encompass all possible mixtures of more than one fluid and/or gas.

II. The disclosed compositions can resist the effects of rapid gas decompression (‘explosive decompression’) as is defined by NACE TM0296, NORSOK M710 or by both procedures, both of which are included herein by reference in their entirety.

III. The disclosed composition are resistant to extrusion when subjected to a differential pressure of at least about 500 psi, in another embodiment at least about 1,000 psi, in a further embodiment at least about 2,000 psi, in a still further embodiment at least about 5,000 psi, in a yet further embodiment at least about 10,000 psi, in a still yet further embodiment at least about 15,000 psi.

The disclosed piezoresistive compositions further comprise a plurality of conductive elements dispersed within the composition, i.e., dispersed within the one or more polymers. The conductive elements utilized in the composition can be a single type, or a mixture of types. In one aspect, at least a portion of the plurality of conductive elements comprises a material having at least one dimension of nanoscale, i.e., at least one dimension less than about 100 nanometers. In another aspect, the conductive element comprises a metallic or semi-metallic material, for example, silver nanorods or flakes.

In a further aspect, the conductive element comprises a carbonaceous material. Non-limiting examples of suitable carbonaceous materials include: carbon nanotubes, carbon nanosprings, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers, or mixtures thereof.

In another aspect, the piezoresistive compositions further comprise carbon black [C.A.S. NO. 1333-86-4]. Carbon black is virtually pure elemental carbon in the form of colloidal particles that are produced by incomplete combustion or thermal decomposition of gaseous or liquid hydrocarbons under controlled conditions. Its physical appearance is that of a black, finely divided pellet or powder. Its use in the disclosed piezoresistive compositions is related to properties of specific surface area, particle size and structure, conductivity and color.

In one aspect of the disclosed piezoresistive compositions the carbon black has a BET surface area of at least about 40 m²/g. In another aspect the carbon black has a BET surface area of at least about 70 m²/g. In a further aspect the carbon black has a BET surface area of at least about 100 m²/g. The carbon black can be a channel black, a thermal black, or an acetylene black.

In the aspect wherein the conductive element comprises carbon nanotubes, the carbon nanotubes may be single wall, double wall, or multi-wall carbon nanotubes, and may be of any suitable length or diameter distribution. In one embodiment of this aspect, at least a portion of the carbon nanotubes are of sufficient length so as to be capable of establishing a percolated network at a low fraction in the one or more polymers. As such, in one iteration less than about 20% by weight of the piezoresistive composition comprises carbon nanotubes. In another iteration, less than about 10% by weight of the piezoresistive composition comprises carbon nanotubes. In a further iteration, less than about 5% by weight of the piezoresistive composition comprises carbon nanotubes. In a still further iteration, less than about 1% by weight of the piezoresistive composition comprises carbon nanotubes.

In one embodiment of the carbon nanotubes comprising the disclosed piezoresistive compositions, the length distribution peak can be from about 100 nm to about 1,000 nm. In another embodiment, the length distribution can be from about 1,000 nm (1 micrometer) to 10,000 nm (10 micrometers). In a still further embodiment, average length distribution can be greater than 10,000 nm.

In a yet further aspect, other materials that are semi-carbonaceous materials, for example, nickel coated graphite, are also suitable for admixture with the one or more polymers comprising the disclosed piezoresistive compositions.

In one still further aspect, the conductive element can be chemically functionalized to improve dispersion within the polymer host, or to improve interfacial characteristics between the conductive element and the polymer host, or to alter the electrical characteristics of the conductive element. One embodiment of this aspect relates to conductive elements that comprise a carbonaceous material. The carbonaceous material can also be functionalized, i.e., can be effected by the establishment of covalent, non-covalent, or ionic attachment of one or more functional groups, oligomers, or polymer chains. In one iteration, the extent of functionalization is conducted to provide sufficient dispersion of the conductive element into the polymer but insufficient to degrade the intrinsic electrical conductivity of the element below a level whereby the desired force measurement or detection can be achieved.

In certain iterations of this embodiment, the carbonaceous material can be functionalized to reduce the intrinsic conductivity of the conductive element, for example, by one or more orders of magnitude as desired by the formulator. In one example, the intrinsic conductivity is reduced by about one order of magnitude. In another example, the intrinsic conductivity is reduced by about two orders of magnitude. In a further example, the intrinsic conductivity is reduced by about three orders of magnitude. Examples of suitable means for functionalizing carbonaceous material includes reaction with thermally decomposed organic peroxides, reaction with aryl or alkyl diazonium species, treatment with various oxidizing agents such as, for example, ozone, various acid mixtures such as sulfuric and nitric acid mixtures, combinations of a strong acid with an oxidant such as potassium permanganate, or treatment with a reactive gas such as fluorine.

A still yet further embodiment relates to the use of two or more types of conductive elements in combination. Non-limiting examples include elements chosen from carbon nanotubes, carbon nanosprings, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers, nickel coated graphite, silver nanorods or flakes, carbon black or graphene.

In one aspect, the piezoresistive composition can be a homogeneous composition with respect to the conductive elements, i.e., only one type of conductive element is present. For example, carbon black is uniformly dispersed throughout the composition. In one embodiment, the one conductive element can be regionalized, for example, a higher concentration of the conductive element can be dispersed between two chosen electrodes or two or more selected arrays of detection cells. In a further embodiment, the conductive element can be absent in one or more regions of the piezoresistive composition.

In another aspect, the piezoresistive composition can be a heterogeneous composition with respect to the conductive elements wherein an admixture of two or more types of conductive elements is present. In one embodiment, the admixture of conductive elements is dispersed homogeneously throughout the piezoresistive composition. In another embodiment, the formulator can disperse different conductive elements at different locations within the composition. This can be done to increase or decrease the electrical conductivity or to increase precision in measuring applied forces.

In one embodiment wherein an combination of more than one type of conductive elements is employed, the combination comprises elements having different geometrical characteristics, for example, a mixture of a high aspect ratio conductive element and a low aspect ratio conductive element. In one iteration, the high aspect ratio conductive element has an aspect ratio that is at least about 2. In another iteration, the high aspect ratio conductive element has an aspect ratio that is at least about 4. In a further iteration, the high aspect ratio conductive element has an aspect ratio that is at least about 10. In a still further iteration the high aspect ratio conductive element has an aspect ratio that is at least about 100. In a yet further iteration the high aspect ratio conductive element has an aspect ratio that is at least about 1,000. Such a mixture may, for example, comprise a mixture of multi-wall carbon nanotubes and graphene in a suitable ratio.

For example, one embodiment can comprise a conductive material having an aspect ratio that is twice as high as a second conductive material that comprises the membrane. In another embodiment, the first material has an aspect ratio at least about ten times higher than the second conductive material. In a further embodiment, the first material has an aspect ratio at least about one hundred times higher than the second conductive material.

In one aspect of the disclosed piezoresistive compositions, an admixture of two or more types of conductive elements can be combined wherein the intrinsic conductivity of the two or more types of elements differs. In one iteration of this aspect the two or more elements differ in their intrinsic conductivity by at least about one order of magnitude. In another iteration of this aspect the two or more elements differ in their intrinsic conductivity by at least about two orders of magnitude. In a further iteration of this aspect the two or more elements differ in their intrinsic conductivity by at least about three orders of magnitude.

The relative amounts of the one or more types of conductive elements dispersed in the at least one polymer comprising the piezoresistive compositions is chosen based on the desired properties. In one aspect, the amount is chosen to be below the percolation threshold, such that the membrane, together with any optionally present additives, exhibits insulating behavior in the absence of applied force. In one embodiment, the amount of the one or more conductive elements is chosen such that the piezoresistive composition has a zero-force resistance of at least about 1 MOhm when incorporated into a sensor of the disclosure. In another embodiment, the amount of the one or more conductive elements is chosen such that the piezoresistive composition has a zero-force resistance of at least about 10 MOhm when incorporated into a sensor of the disclosure. In a further embodiment, the amount of the one or more conductive elements is chosen such that the piezoresistive composition has a zero-force resistance of at least about 100 MOhm when incorporated into a sensor of the disclosure.

In one aspect of the disclosed piezoresistive compositions the piezoresistive composition comprises from about 0.5% by weight to about 20% by weight of one or more conductive elements. In another aspect of the disclosed piezoresistive compositions, the piezoresistive composition comprises from about 0.5% by weight to about 15% by weight of one or more conductive elements. In one aspect of the disclosed piezoresistive compositions, the piezoresistive composition comprises from about 5% by weight to about 15% by weight of one or more conductive elements.

In one embodiment wherein the piezoresistive compositions comprise a combination of types of conductive elements, the ratio of the different types of conductive elements can be from about 1:1 to about 1.5:1, or from about 1.6:1 to about 5:1 in favor of one type of conductive element.

In one aspect wherein the piezoresistive composition comprises more than one polymer, the mixture thereof can comprise a single continuous phase blend, wherein only one glass transition temperature (T_{g}) is observed. In another aspect the mixture thereof can comprise a co-continuous two phase blend. In yet another aspect the mixture thereof can comprise a distinct two phase, three phase, or four or more phase blend, wherein the number of distinct phases is at least two and is equal to the number of different polymers comprising the piezoresistive composition. In an aspect wherein the piezoresistive composition comprises more than one polymer and does not comprise a continuous phase blend, the plurality of conductive elements can be preferentially located in or more phases, and can be absent from one or more phases. In another aspect wherein the piezoresistive composition comprises more than one polymer and does not comprise a continuous phase blend, the plurality of conductive elements can be preferentially located at or near the phase boundaries. In yet another aspect, the preferential location of the plurality of conductive elements at or near the phase boundaries in comprises a segregated network. Throughout the disclosure, the term ‘different polymers’ should be understood to mean: (a) polymers of different chemical composition, or (b) polymers of the same or similar chemical composition but of different molecular weight distributions, or (c) polymers of the same or similar chemical composition but exhibiting different stereochemistry or regiochemistry, such as for example syndiotactic, isotactic, or atactic.

The plurality of conductive elements or mixture of conductive elements can be dispersed into the polymer host by a means suitable to provide sufficient dispersion such that the desired resistivity response to applied force is achieved. Various means are suitable, including melt blending, internal mixer mixing (Banbury or Brabender style mixers), chaotic mixing, or roll milling. Alternatively, the plurality of conductive elements or mixture of conductive elements can be dispersed into the polymer host via solution based processing such as by incipient wetting. In yet another aspect, the plurality of conductive elements or mixture of conductive elements can be dispersed via solution-based processing wherein the polymer host is dissolved in a suitable solvent or mixture of at least two solvents, the at least two solvents comprising at least a primary solvent and at least one co-solvent. Suitable solvents include, but are not limited to, solvents having a solubility parameter and/or other features such that the second virial coefficient, B, as related to the excess chemical potential of mixing, is greater than zero. The plurality of conductive elements or mixture of conductive elements can be added thereto as a dry powder, or as a suspension or solution in a suitable solvent or mixture of solvents that may be the same as the solvent or the more than one solvent in which the polymer host is dissolved, or may be different from the solvent or more than one solvents in which the polymer host is dissolved. Non-limiting examples of suitable solvents include tetrahydrofuran, acetone, methyl ethyl ketone, hexane, heptane, and other hydrocarbon or oxygenated hydrocarbon solvents. Other solvents are known in the art as suitable for dispersion of carbonaceous conductive materials and are suitable for the purpose. The mixture formed therefrom can optionally be energized to facilitate dispersion. In one aspect, the mixture formed therefrom is energized by at least one method selected from amongst ultrasonic agitation, high shear mixing via a rotor-stator type mixer, wet media milling, or resonant acoustic mixing. Any of the aforementioned methods can optionally be operated at either elevated temperature (i.e. above about 25° C.) or reduced temperature (i.e. below about 25° C.) in order to affect the viscosity of the mixture and thereby the shear imparted to the mixture. In another aspect, any of the aforementioned methods can optionally be operated at elevated pressure (i.e. above atmospheric pressure), such as from about 10 psig to about 100 psig, or from about 25 psig to about 75 psig, or from about 40 psig to about 60 psig, in order to enhance the energizing of the mixture. The process of dispersing the plurality of conductive elements can be further facilitated by use of a dispersant for the purpose of effecting surface energy modification of the conductive elements thereby facilitating the thermodynamics of mixing. Suitable dispersants include, but are not limited to, various surface-active agents (surfactants) including anionic, cationic, and non-ionic surfactants. Other suitable dispersants include various polymers or oligomers known in the art to facilitate dispersion of carbonaceous materials in various polymer matrices. Certain ionic liquids, such as, for example, imidazolium salts, are also useful for the purpose. At least a portion of the plurality of conductive elements may optionally be pre-treated prior to dispersion into the polymer host by one or more of jet milling, cryo-grinding, media milling, or high temperature annealing in an inert atmosphere or vacuum.

In aspects wherein the conductive element comprises a material with an aspect ratio greater than about 5, or greater than about 10, at least a portion of the plurality of conductive elements can be preferentially oriented within the polymer host. In an aspect wherein at least a portion of the plurality of conductive elements is preferentially oriented within the polymer host, the orientation may be substantially in-plane or substantially through-plane depending on the intended end use. Furthermore, in the aspect wherein the orientation is substantially in-plane, the oriented portion of conductive elements can further be substantially of coincident alignment in the plane of the membrane. Alignment can be implemented by applying at least one technique selected from amongst shear flow processing, a magnetic field, or an electric field.

The disclosed piezoresistive compositions membrane can further comprise one or more adjunct ingredients, such as, for example, plasticizers, rheological aids, fillers and/or reinforcing agents, curing (setting, or vulcanizing) agents, coagents, and/or other items known to those skilled in the art of polymer compound formulation.

In one aspect the piezoresistive composition is designed to be biodegradable over a predictable period of time and/or exposure to certain environmental conditions. In another aspect, the polymer comprising the piezoresistive composition is a biocompatible polymer. In yet another aspect, the polymer comprising the piezoresistive composition is a chemically inert polymer. In yet another aspect, the piezoresistive composition, is designed to be selectively swellable in hydrocarbon based fluids, or selectively swellable in aqueous based fluids, or selectively swellable in certain gases. In this aspect, the selective swelling in hydrocarbon based fluids, aqueous based fluids, or various gases, can be used to cause deformation of the membrane thereby effecting a change in resistivity of the piezoresistive composition or the resistance measured by the disclosed sensor comprising the piezoresistive composition. Preferably the polymer comprising the piezoresistive composition is able to be repeatedly deformed to a high strain amplitude, for example to at least about 10%, without mechanical failure. In another aspect, the polymer composition has a glass transition temperature of less than about 0° C. In another aspect, the polymer composition has a glass transition temperature such that at the intended temperature of operation of a device made therefrom, the composition exhibits viscoelastic behavior, such as is exhibited in the ‘rubbery plateau’.

In one aspect wherein the piezoresistive composition comprises a membrane, the membrane is substantially uniform in thickness across its surface area. In one embodiment the membrane has a uniform thickness of from about 100 nm to about 100 micrometer. In another embodiment the membrane has a uniform thickness of from about 101 nm to about 1 mm. In a further embodiment the membrane has a uniform thickness of from about 1 mm to about 1,000 mm. The formulator, however, can modify the thickness to any convenient amount so as to have the optimal functionality depending upon the specific application.

In another aspect of the membranes, the surfaces can have one or more roughness. In one embodiment, at least one surface of the membrane has a surface roughness of less than about 500 nm. In another embodiment, at least one surface of the membrane has a surface roughness of less than about 200 nm. In a further embodiment, at least one surface of the membrane has a surface roughness of less than about 100 nm. In a yet further embodiment, at least one surface of the membrane has a surface roughness of less than about 10 nm.

In one embodiment of this aspect, the surface roughness of one surface is different than the corresponding roughness of the other surface. In one iteration the surface roughness of one side is about 50% less than the roughness of the other side. In another iteration the surface roughness of one side is about 25% less than the roughness of the other side. In a further iteration the surface roughness of one side is about 10% less than the roughness of the other side.

The membrane can be formed by any method chosen by the formulator. Non-limiting example methods include compression molding, transfer molding, film blowing, tape casting, dip coating, spin coating, spraying, or calendaring. The membranes thus formed have a first surface and a second surface.

In one aspect, the disclosed piezoresistive compositions exhibit a change in resistivity upon deformation of the piezoresistive composition, application of a force thereto, or both, i.e. a piezoresistive response. In one embodiment, deformation of the piezoresistive composition can be caused by application of a force at any angle relative to the membrane surface. In another embodiment, deformation of the piezoresistive composition can be caused by a change in temperature. In yet another embodiment, deformation of the piezoresistive composition can be caused by contacting the piezoresistive composition with a liquid or with a gas or a combination of the two. In yet another embodiment, the resistivity of the piezoresistive composition can be altered upon a change in differential pressure across the piezoresistive composition. In still yet another embodiment, the resistivity of the piezoresistive composition can be altered upon impingement of the piezoresistive composition to a textured surface. In one aspect, the resistivity of the piezoresistive composition is reduced upon application of a force, or pressure, thus exhibiting a Negative Pressure Coefficient, or NPC. In another aspect, the resistivity of the piezoresistive composition is increased upon application of a force, thus exhibiting a Positive Pressure Coefficient, or PPC. The end use, or application, of the membrane can determine whether a NPC or a PPC is most desirable. In one aspect it is desirable that the average spacing between conductive elements comprising the piezoresistive composition is altered upon deformation of the membrane.

In a still further aspect, the resistivity of the disclosed piezoresistive compositions can change by any amount desirable to the formulator. In one embodiment, the resistivity of the piezoresistive composition changes by at least about one order of magnitude, at least about two orders of magnitude, or at least about three orders of magnitude in response to a particular applied force.

### Detection Cell

The disclosed systems and sensors further comprise at least one detection cell comprising at least two electrodes. The electrodes can pass a current between one another. If the sensor, piezoresistive composition, or membranes have a force applied thereto, the resistivity of the piezoresistive composition or membrane will change. This change can be measured according to the desire of the user, for example, a disclosed sensor measuring a change in resistance or a change in current flow.

In one aspect, the detection cell comprises two electrodes. The electrodes can be configured in any pattern chosen by the user. The disclosed piezoresistive compositions serve as an electrical bridge that connects, or is in contact with, the at least two electrodes. In this manner, changes in the resistivity of the piezoresistive compositions, as described herein, result in a change in resistance in the circuit comprising the piezoresistive composition and at the least two electrodes.

The detection cells which comprise the disclosed sensors can further comprise a means for measuring the electrical properties of the piezoresistive compositions that comprise the sensors. In certain embodiments, the means for measuring the electrical properties comprises microelectromechanical (MEMS) technology. In other embodiments, the means for measuring the electrical properties of the piezoresistive composition comprises a series of a plurality of electrodes separated from one from another at discrete distances.

In another aspect the detection cells can comprise a plurality of electrodes that are an array of Schottky diodes in electrical communication with the piezoresistive composition. In one embodiment of this aspect the diodes comprising the Schottky diode array are supported on or affixed to a substrate, and are in contact with the disclosed piezoresistive composition which comprises the disclosed sensors. In another aspect, the electrode or electrodes are supported on or affixed to a flexible and insulating substrate together with the disclosed piezoresistive composition, together comprising the sensor of the disclosure. Suitable substrates include flexible and electrically insulating materials such as polyethylene terephthlate (PET) or Mylar. Other suitable flexible and insulating substrates are known in the art and are suitable for the disclosure. In one aspect wherein the insulating substrate is flexible, said substrate is capable of repeated flexion, and further to have a bending radius such as that membrane can be curved to very small radius of curvature without breaking, wherein single instance or repeated flexion of the substrate does not result in cracking or otherwise permanent degradation. In other aspects, the insulating substrate is a rigid material, such as, for example, silicon or glass. The diodes and/or electrodes can be arranged in any manner selected by the user, for example, in a regular pattern, or array where the spacing between electrodes in a detection cell is uniform and fixed, or variable. In another embodiment of this aspect the individual electrodes that comprise a detection cell are uniform in size. In another embodiment, the electrodes that comprise a detection cell vary in size, or alternatively, the electrodes can be grouped according to their size. The user can select the size, spacing, and final arrangement of the electrodes in a detection cell depending upon the desired spatial resolution the user desires. For example, in certain embodiments it is desirable to achieve a high spatial resolution, wherein a closer spacing between the electrodes is desirable. One iteration provides spacing of less than about 5 micrometer. In other iteration, the spacing between the electrodes can be from about 5 micrometer to about 2000 micrometer. In still another iteration, the electrodes are arranged in an array, non-limiting examples of which include arrays having the following configurations 2×2, 3×3, 4×4, 16×16, 1×2, 2×4, or 4×8. The number of number of detection cells in the array, however, can be of any suitable configuration or size.

The size of the individual electrodes is similarly chosen to be suitable for a particular end use. For example, in certain aspects, the electrodes can be from about 1 micrometer to about 2000 micrometer in diameter. In another aspect, the electrode can be from about 10 micrometer to about 100 micrometer. In a further aspect, the electrode can be from about 20 micrometer to about 100 micrometer. In as still further aspect, the electrode can be from about 30 micrometer to about 100 micrometer. The electrodes themselves can function in any manner compatible with the user's desire. For example, the electrode can function as a component of a transistor, (source, drain, or gate), a diode, or a resistor. The user can provide electrical communication between at least a portion of and as many as all of the electrodes.

In one iteration of the disclosed sensors and information communicated therefrom:
i) the user can further transmit any information gleaned from this aspect to any persons and/or agencies locally or worldwide;
ii) groups or arrays of electrodes can be electrically addressable as a group
iii) passive circuitry can be employed for the purpose of addressing the electrode or electrodes; or
iv) active matrix circuitry can be used for the purpose of addressing the electrode or electrodes.

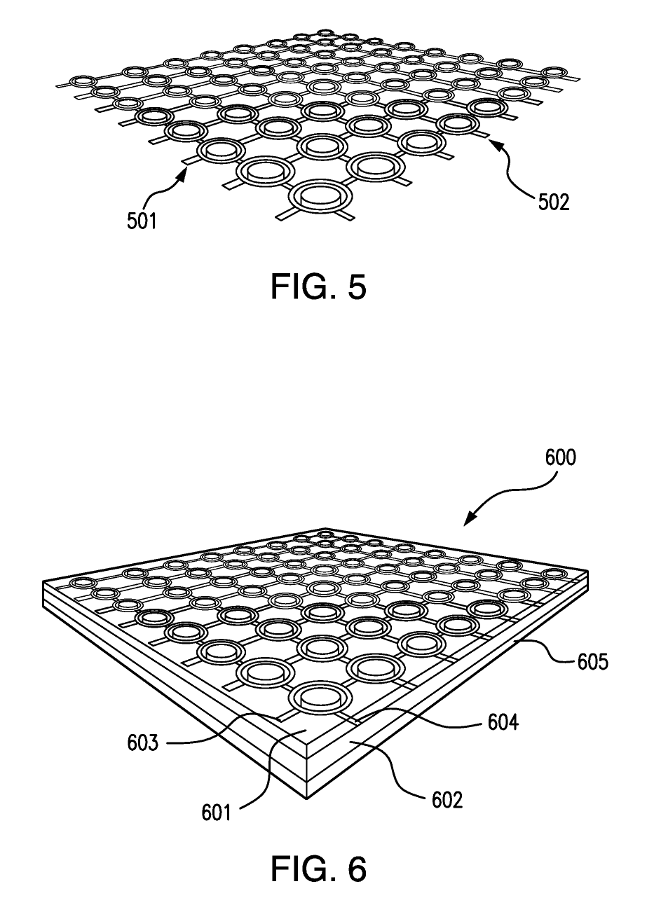

Provision is made for electrical communication between at least a portion of and as many as all of the electrodes. Further provision is made for connection or communication with the outside world. In one aspect, each individual electrode is electrically addressable. In another aspect, groups or arrays of electrodes are electrically addressable as a group. In one aspect, passive circuitry is employed for the purpose of addressing the electrode or electrodes. In another aspect, active matrix circuitry can be used for the purpose of addressing the electrode or electrodes. In one aspect the circuitry is fabricated using thin film circuitry with amorphous Si as the active semiconductor. Other semiconductors are also suitable for the disclosure, such as, for example, semiconductors from Groups II-VI of the Periodic Table of Elements, such as CdS, ZnO, InZnO, and InGaZnO. Organic-based transistors are also suitable for the disclosure. In one aspect, the force sensor of the disclosure comprises an arrangement of electrical sensing elements further comprising a Schottky or p-n junction diode array, as depicted in FIG. 4 and FIG. 5. In various aspects, the array is fabricated by photolithography, inkjet or reel-to-reel methods. The electrodes and active components of the diodes can be deposited onto or affixed to the substrate by one or more means, such as vapor deposition, lithography, ink jet printing, or screen printing. Other means of electrode deposition are known in the art and are suitable for the disclosure. In certain aspects, the electrodes are arranged in such as a way that the device is capable of geographically locating a change in resistance of the membrane of the disclosure. For example, a certain electrode or set of electrodes will detect a change in resistance, whereas other electrode(s) spatially displaced from the first electrode or set of electrodes will detect a smaller change or no change in resistance. In certain aspects, the change in resistance, whether local or global, by way of reference to a calibration data set, is able to be translated into a local or global applied force, pressure, or strain.

The disclosed sensors, comprising a piezoresistive composition and at least one detection cell, are operable to detect or measure a force or pressure applied thereto. In one aspect, the detect or measure function comprises detecting or measuring a change in resistance. In one embodiment, the measured resistance changes by at least one order of magnitude in response to a particular applied force, i.e., from about 100 MOhm to about 10 MOhm, or from about 10 Ohm to about 1 Ohm. In another embodiment, the measured resistance changes by at least two orders of magnitude in response to a particular applied force. In a further embodiment, the measured resistance changes by at least three orders of magnitude in response to a particular applied force. In a still further embodiment, the measured resistance changes by at least four orders of magnitude in response to a particular applied force. In a yet another embodiment, the measured resistance changes by at least five orders of magnitude in response to a particular applied force.

In yet still another aspect of the disclosed sensors, the sensors can exhibit a change in resistance that corresponds to the amount of a force acting upon the piezoresistive composition as determined by the formulator. In one embodiment, the change in resistance is at least about three orders of magnitude when a force from about 0.01 Newtons (N) to about 20 N is applied thereto. In another embodiment, change in resistance is at least about three orders of magnitude when a force from about 20 Newtons (N) to about 500 N is applied thereto. In certain embodiments, the change in resistance is at least about three orders of magnitude when a force greater than about 500 N is applied thereto.

The disclosed sensors can recover from deformation caused by an applied force whether the deformation is positive or negative. In one aspect, the resistance is recoverable to about 60% or more, about 70% or more, about 80% or more, about 90% or more, or about 100% of the original value prior to application of the force. In certain aspects is it desirable to modulate the response of the sensor in relation to an applied force, for example to achieve a similar change in resistance but over a wider range of applied force. In other aspects, it is desirable to translate, or shift, the resistance versus force response of the sensor to a higher force regime, for example to alternatively provide a sensor suitable for distinguishing between two light weight objects, or to provide a sensor suitable for distinguishing between a passenger car and an armored personnel carrier. Many other examples of objects can be given, and those listed herein are not limiting in any respect. As described herein, the applied force can be via impingement of a physical object against the sensor, by a change in hydrostatic pressure, or by change in differential pressure.

In one aspect the sensor is encapsulated in a coating material so as to prevent or minimize the effect of ambient humidity or contact of conductive or electrolyte containing liquids with the membrane. In another aspect, the sensor exhibits a resistance vs. applied force relationship that can be described in a mathematically predictable manner, e.g. by a continuous function of one or more variables. In one aspect, the resistance vs. applied force relationship can be described by an exponential function according to the formula:

R(f)=Rₒe^{-lf}

wherein ‘R’ is the resistance at an applied force of ‘f’, ‘Rₒ’ is the resistance at an applied force of 0, ‘e’ is Euler's Number, ‘l’ is the decay constant. In this example, the exponential function describes a decaying value as signified by the negative sign preceding the exponential component. It is understood that the relationship could also comprise an exponentially increasing function. In another aspect the sensor can exhibit a resistance vs. applied force relationship that can be described according to the formula:

R(f)=Rₒe^{-(f-f(o))/l}+b

wherein f(o) is the initial force and ‘b’ is a constant, such that the relationship can be described in a case wherein there is a resistance offset, or wherein the resistance change does not start at force=0. In still other aspects, the sensor's resistance vs. applied force relationship can be described by a multi-component exponential function. In yet still other aspects, the sensor's resistance vs. applied force relationship can be described by a non-exponential mathematical function. In various aspects, the sensor can exhibit a rapid change in resistance over a small force range, or a slow force change over a wide force range, the exact nature being described by a mathematical function. The precise relationship is selected in light of the desired application.

In one aspect the disclosed sensors can exhibit a low hysteresis with respect to the resistance change, whether in-plane or through-plane or both in-plane and through-plane. In one embodiment, the hysteresis is less that about 10% of the measured change in resistance. In another embodiment, the hysteresis is less that about 5% of the measured change in resistance. In a further embodiment, the hysteresis is less that about 2% of the measured change in resistance.

A further aspect of the disclosed sensors relates to sensors that exhibit a low resistance creep, or change in resistance, whether in-plane or through-plane or both in-plane and through-plane, when subjected to a fixed or a constant applied force or deformation. In one iteration of this aspect, the creep is less than about 20% of the creep over a period of from about 5 minutes to about 5 hours. In another iteration of this aspect, the creep is less than about 15% over a period of from about 5 minutes to about 5 hours. In a further iteration of this aspect, the creep is less than about 10% over a period of from about 5 minutes to about 5 hours. In a yet further iteration of this aspect, the creep is less than about 5% over a period of from about 5 minutes to about 5 hours.

In one aspect, the disclosed force sensors can comprise one or more of the disclosed membranes, the membranes comprising piezoresistive compositions. For example, the membranes can be layered, and as such, the sensor can comprise, for example, two, three, four, five, six, seven or more membranes. In one iteration, each of the membranes has the same force threshold. Alternatively, each membrane can have different force thresholds. In addition, a combination of membranes can be utilized wherein two or more of the membranes have the same force thresholds. Disclosed, therefore, are a combination of any and all possible combinations of membranes with different force thresholds.

For the disclosed sensors, when the force threshold is stated as 10 N, it is understood that the force threshold is within a finite range wherein 10 N occupies the median value, for example, a range from about 9.0 N to about 11.0 N, or from about 8.0 N to about 12.0 N. As it relates to the present disclosure, the finite range of force comprising the force threshold can be from about 10% of the median value below the median value to about 10% of the median value above the median value. In another iteration, the finite range of force comprising the force threshold can be as low as from about 5% of the median value or as great as 20% of the median value. For example, in aspects wherein there is a plurality of layered membranes, a first membrane can have a force threshold of 50 N, thereby the change in resistivity of the membrane or resistance of the sensor upon an applied force between about 0-45 N does not cause a change in resistivity of the membrane or resistance of the sensor of more than one order of magnitude, while a second membrane can have a force threshold of 500 N, while a third of the more than one membranes has a force threshold of 1,000 N. It is understood that the differences in force thresholds among the more than one membranes can be of any magnitude, depending on the desired operation of the force sensor and the requisite resolution. It is further understood that the membranes comprising the force sensor can have any force threshold greater than zero chosen by the formulator, for example, about 1 N, about 5 N, about 10 N, about 100 N, about 1,000 N, about 10,000 N or more.

Different force thresholds can be accomplished by varying the components that comprise the membrane, by varying the thickness of the membrane, or by varying the surface roughness of the membrane. In another aspect, the thickness of all of the more than one membranes can be substantially similar, while in other aspects they can be of varying thickness. The appropriate distribution of thicknesses is chosen based on the desired end-use application. In another aspect, the more than one membranes comprising the force sensor are each addressed individually and are in individually in contact with suitable electronics, such as top and/or bottom electrodes and/or Schottky diode arrays, as described herein, such that each membrane provides a unique output. In this manner, the force sensor can be used to define the range of force applied to the sensor. For example, if a force of 150 N is applied to a force sensor comprising three membranes, the first of which has a force threshold of 10 N, the second of which has a force threshold of 100 N, and the third has a force threshold of 300 N: the first membrane can exhibit a change in resistivity of more than one order of magnitude because the applied force is above that membrane's force threshold; the second membrane can exhibit a change in resistivity of more than one order of magnitude because the applied force is above that membrane's force threshold; the third membrane can exhibit a change in resistivity of less than one order of magnitude because the applied force is below that membrane's force threshold. In this manner, the output can be used to identify the applied force as being from at least about 100 N to about 299 N. In one aspect, at least one of the more than one membranes exhibits a resistivity that is an exponential function of the applied force.

In another aspect, each of the more than one membranes exhibits a resistivity vs. applied force relationship that can be described in a mathematically predictable manner, e.g. by a continuous function of one or more variables. In one aspect, the resistivity vs. applied force relationship can be described by an exponential function according to the formula:

R(f)=Rₒe^{-lf}

wherein ‘R’ is the resistivity at an applied force of ‘f’, ‘Rₒ’ is the resistivity at an applied force of 0, ‘e’ is Euler's Number, ‘l’ is the decay constant. In this aspect, the exponential function describes a decaying value as signified by the negative sign preceding the exponential component. It is understood that the relationship could also comprise an exponentially increasing function. In another aspect, at least two of the more than one membranes exhibit different decay constants, such that their respective resistivity vs. applied force relationship can be graphically depicted as in FIG. 8, which shows by way of example three different such relationships. In another aspect, at least one of the more than one membranes exhibit a resistivity vs. applied force relationship that can be described according to the formula:

R(f)=Rₒe^{-(f-f(o))/l}+b

wherein f(o) is the initial force and ‘b’ is a constant, such that the relationship can be described in a case wherein there is a resistivity offset, or wherein the resistivity change does not start at force=zero. In another aspect, the more than one membranes are in direct contact with each other, without supporting electronics or other layers or substrates between. In this aspect, the entire sandwich configuration is addressable as a single unit wherein there are multiple membranes, disposed one on top of another, with only one outermost layer or layers in direct contact with suitable electronics, such as top and/or bottom electrodes and/or Schottky diode arrays, as described herein. In this aspect, the more than one membrane may have the same or different composition, may have the same or different force thresholds, and may have the same or different decay constants; regardless, the entire sandwich configuration operates as a single unit. In one aspect wherein the more than one membrane comprising the force sensor are in direct contact with each other, without supporting electronics or other layers or substrates between, the response of the force sensor to applied force, as described in a graph of resistivity vs. applied force, does not exhibit exponential change in resistivity with applied force, meaning the relationship is described by a mathematical function other than an exponential rise or decay to an arbitrary value. Herein, exponential rise or decay to an arbitrary value means either a single or a multi-component exponential rise or decay to an arbitrary value.

### DETAILED DESCRIPTION OF THE DRAWINGS

FIGS. 1A and 1B provide a general depiction of the disclosed systems which utilize the disclosed piezoresitive compositions. In FIG. 1A a piezoresistive composition 101 is positioned between two electrodes 102 and 103 to form sensor 100. The electrodes are in contact with the piezoresitive composition. A voltage applied between electrodes 102 and 103 will pass a current i through the piezoresistive composition. This amount of current will be directly related to the resistive properties of the composition. In FIG. 1B, a force has been applied to sensor 100 causing a deformation in composition 101. The deformation of piezoresistive composition 101 due to the applied force results in a change in the current, Di, flowing between electrodes 102 and 103. This change is current is due to the change in the electrical resistance in the compressed piezoresistive composition. This change in current can be correlated to the amount of force exerted upon sensor 100 as depicted in FIG. 1B.

FIG. 2 depicts another embodiment of the disclosed sensors. Sensor 200 comprises piezoresistive composition 201 having electrodes 202 and 203 positioned on the same surface. Like the embodiment depicted in FIGS. 1A and 1B, deformation of the sensor by an applied force, either upward or downward, will cause a change in the resistive properties of composition 201 which can be correlated to the amount of applied force.

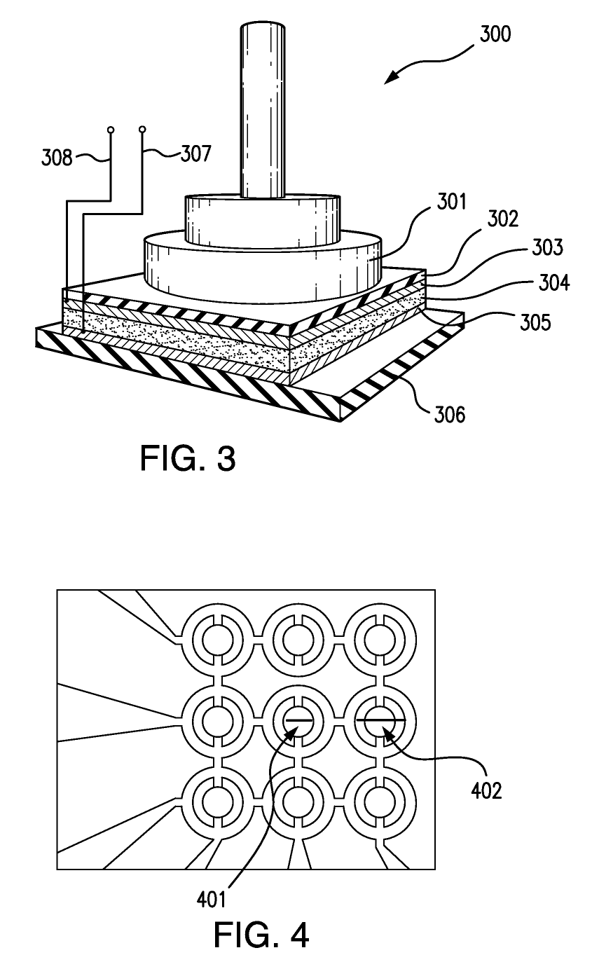

FIG. 3 depicts a method and apparatus 300 for measuring one or more of the properties of the disclosed piezoresistive membranes. A force can be applied by plunger 301. A piezoresistive composition 304 is positioned between a first conductive material 303 which serves as a first electrode and second conductive material 305 which serves as a second electrode. The piezoresitive composition/electrode assembly is electrically isolated by insulating plates 302 and 306. Wire 308 is in electrical communication with electrode 303 and a source of electrical current. Wire 307 is in electrical communication with electrode 305 and the source of electrical current. After obtaining an initial current flow, i, through the composition 304, force is applied to via plunger 301 to the piezoresitive composition/electrode assembly. The observed change in current, Δi, can then be correlated to the amount of force applied, either continuously, or a particular times.

Referring to FIG. 4, this figure depicts a Schottky diode array suitable for use in the disclosed sensors. The distance indicated by the black bar 401 is 30 μM whereas the distance indicated by black bar 402 is 60 μM which indicates the relative size of a suitable Schottky diode array. It is understood that both distances can be any suitable distance and can be chosen by the operator.

FIG. 5 depicts another view of a suitable diode array wherein 501 is a first electrical connection and 502 is a second electrical connection.

FIG. 6 depicts a sensor 600 comprising a Schottky diode array configured for use according to the present disclosure. A series of first electrical connections 603 are in electrical communication with the outside surface of conducting layer 601 that consists of a disclosed piezoresistive composition. A series of second electrical connections 604 extend downward through conducting layer 601 to the bottom surface of layer 601. Layer 601 is deposed upon non-conducting insulating layer 602 which is in turn deposed upon a second non-conducting layer 605. Each electrode pair 603 and 604 is in electrical communication with a source of electrical current. A force applied to any point of the underlying surface 601 will cause a change in resistance to be measurable at the respective diode(s). In this manner the artisan can determine the point along the piezoresistive resistive layer that a force has been applied by measuring any changes or lack of changes in resistance along the array.

FIG. 7 depicts the response curve of a disclosed sensor as further described in Example 1.

FIG. 8 depicts graphical representations of potential response curves of disclosed sensors to an applied force.

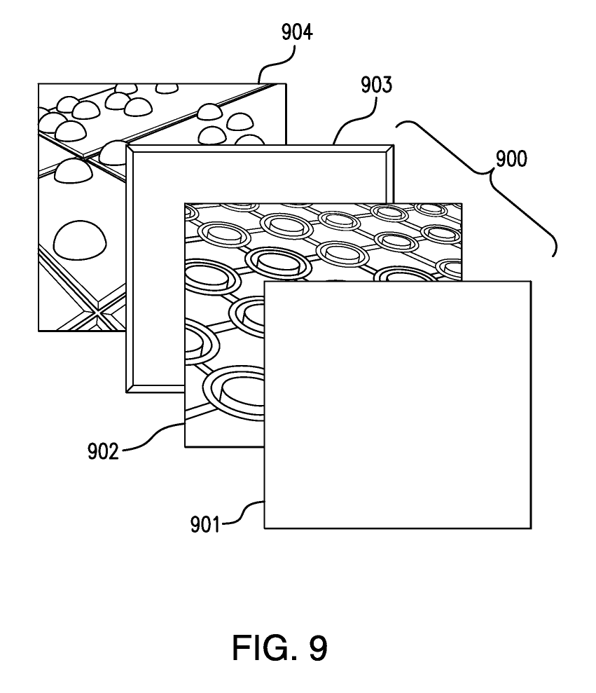

FIG. 9 depicts a sensor 900 according to the present disclosure useful for reading Braille, as represented by 904. The sensor 900 comprises an insulating layer 901, a diode array 902, and a piezoresistive composition 903. In one iteration, the electrical signals received can be converted via an appropriate algorithm to audible frequencies.

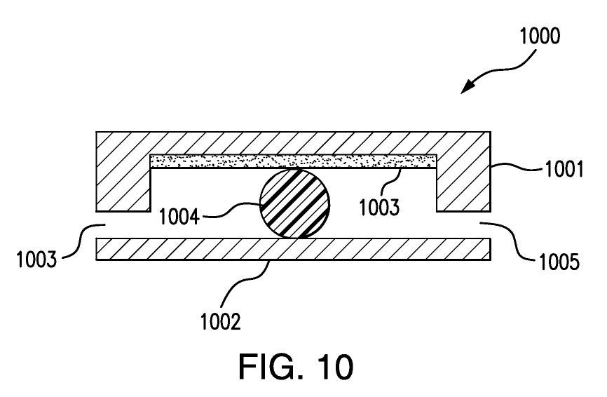

FIG. 10 depicts an assembly 1000 comprising an o-ring seal 1004 located within the gland created by housing 1001. The o-ring can control flow between openings 1003 and 1005. O-ring seal 1004 impinges upon a surface of housing 1001 and thereby upon disclosed sensor 1002 that is disposed between the o-ring 1004 and the housing 1001. The force or change in the force applied by o-ring 1004 can be detected or measured by the sensor 1002.

FIGS. 11A and 11B depict an example of the use of a wellbore packer to form a seal in a wellbore wherein the packer a sensor according to the present disclosure. The packer comprises a conduit or mandrel 1103, sensor 1105, slip rings 1104 and sealing elements 1106. FIG. 11A depicts a packer prior to use in a wellbore. As shown in FIG. 11A the sealing elements 1106 are in an un-activated state. Because the overall outer diameter of packer 1100 is less than the inner diameter of the wellbore casing 1102, annulus 1101 is formed. FIG. 11B depicts the packer alignment with the wellbore casing after activation. Once subjected to an activating means, sealing elements 1106 expand and make contact with sensor 1105 that is circumferentially deposited along a portion of the inner wall of wellbore 1102, thereby forming a seal and forming upper annulus 1107 and lower cavity 1108. When the sealing elements 1106 contact sensor 1105 the resulting force changes the resistivity of sensor 1106.

The sensor 1105 can be used to detect or measure the force applied thereto by the packer elements 1106. In one iteration, the sensor 1105 is can also be used to locate the position at which the force is applied. For example, if only one packer element 1106 has made contact with sensor 1105, this fact can be detected and reported to the operator. Likewise if only two packer elements 1106 have made contact with sensor 1105, this fact can be detected and reported to the operator. In some embodiments, wherein the sensor of the disclosure comprises multiple electrodes in electrical contact with the piezoresistive composition of the disclosure, the associated analysis software of the disclosure produces a force map wherein the sealing force applied by the seal is spatially resolved across surface area of the seal. In this and other embodiments, it is to be understood that the position of the disclosed sensor in relation to seals, housing, and other aspects can be of any desired relation. For example, in the present embodiment, the sensor can be disposed in proximity to the conduit 1103, in proximity to the outer surface of packer elements 1106, or in proximity to the sealing surface which is the inner surface of wellbore 1102 as depicted in FIGS. 11A and 11B. As such, the sensor is positioned and configured in such a manner as to receive an applied force. The disclosed sensors and piezoresistive compositions can be used as a method for sensing whether a seal has been engaged, for example, a seal used in drilling operations. In one aspect of the disclosed methods, a signal is sent to the operator that there is full engagement of the packer elements or only partial engagement of the packer elements and in which case it may be necessary to apply additional force.

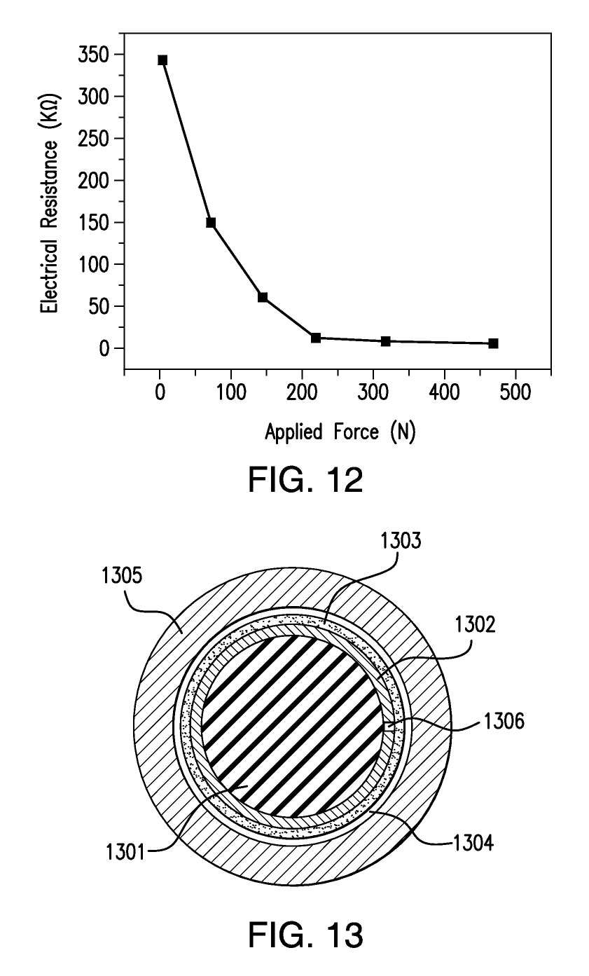

FIG. 12 depicts the change in electrical resistance versus an applied force to a piezoresistive composition as described in Example 2.

FIG. 13 depicts a cross-section view of the system described further in Example 2.

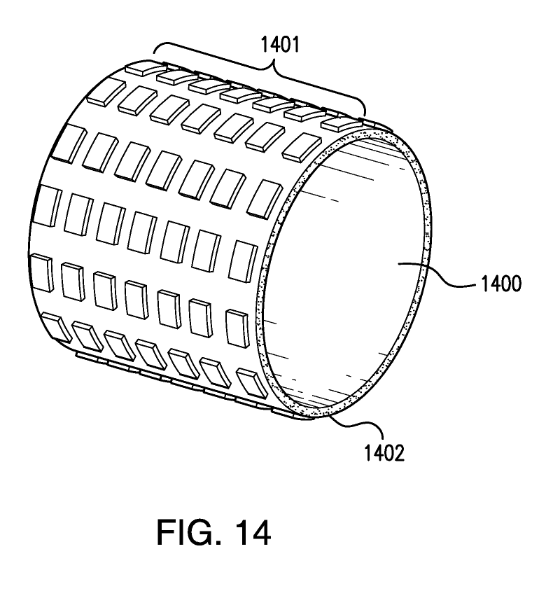

FIG. 14 depicts an embodiment of a disclosed sensor wherein an array of electrodes or diodes 1401 is positioned along and in electrical communication with the circumference of a piezoresistive composition 1402, further comprising an open inner space 1400 such that the sensor can be disposed about the outer surface of a seal or the inner surface of a sealing surface as described herein.

### Methods

Disclosed herein are methods for measuring an applied force. In a first aspect disclosed herein is a method for measuring an applied force, comprising measuring the change in resistance when the applied force contacts a sensor, the sensor comprising:

a) a piezoresistive composition; and

b) at least one detection cell containing at least two electrodes.

The disclosed sensors can be used for the following methods and sensors.

In one embodiment, the disclosed sensors can be used to read or analyze Braille printing, i.e., Braille characters (cells), thereby functioning as a Braille reading device. In one embodiment of this aspect, the Braille reader can be assembled as depicted in FIG. 9. In general, an electrical sensing device, in this instance Schkotty diode array 902 of the disclosure comprises a membrane, an electronics layer, and an insulating electrode support, as described herein and represented schematically in FIG. 9. In another aspect, the Braille reader of the disclosure is in the form of a glove wherein the sensing portion or device is affixed to or embedded in one or more digits of the glove. In another aspect, the Braille reader of the disclosure is in the form of a stylus-like device that can be used in a manner similar to a pen or marker. In any aspect, the Braille reader of the disclosure comprises a suitable configuration that allows for detection of and the distinguishing between the dots which comprise a Braille cell. As such, when applied to a surface upon which Braille cells are presented, the force caused by pressing a Braille reader to the raised dots results in local resistivity changes in the membrane of the device by virtue of the difference in pressure between the dots and the spaces without dots. Thereby the Braille reader of the disclosure can be used can be used to detect the position of and distinguish between each dot in each Braille cell, which constitutes a character, number or operator. In one aspect, the active area of the Braille reader of the disclosure is from about 3 mm to about 9 mm, or from about 4 mm to about 8 mm, or from about 6 mm to about 7 mm. In another aspect, the Braille reader of the disclosure comprises a force sensor operable to detect a change in resistance of the disclosed membrane induced by raised portion or dot of from about 1.3 mm to about 1.6 mm, or from about 1.4 mm to about 1.5 mm in diameter. In another aspect, the Braille reader of the disclosure further comprises a force sensor having a lateral resolution operable to the distinguish between raised portions of printed Braille separated by from about 2 mm to about 3 mm, or by about 2.28 mm. In yet another aspect, the Braille reader of the disclosure can be used to be moved laterally along a line of printed Braille. In one aspect, the Braille reader of the disclosure further comprises electronic circuitry, software, and computer connectivity to make the device operable to translate Braille into another format such as printed or electronic text in any language, into audible sound in any language, or into patterns of vibration of a connected device. Via associated software, the electrical signal resulting from the change in disclosed membrane resistivity from each dot is correlated to a Braille character further translated into an audible form. The Braille reader of the disclosure is useful for teaching Braille to visually impaired or severely dyslexic individuals. In another aspect, the Braille reader of the disclosure is useful to verify the accuracy of Braille labeling on packaging containing active ingredients or components, such as medicaments or pharmaceuticals.

In another embodiment, the sensor of the disclosure can be used as a biometric reading or sensing device, such as can be used to read and identify fingerprint patterns. The biometric sensor of the disclosure detects a pressure differential between individual ridges and valleys in the digit (tip of the finger) when applied to the sensor. In one aspect, the biometric sensor of the disclosure further comprises electronic circuitry such that the data generated is communicated via wired or wireless connectivity to an associated device such as a computer, smart phone, or other electronic device. In a further aspect, the biometric sensor of the disclosure comprises software that collects input data and translates said data into a visual or mathematical description or depiction such as a color-coded or topographic representation of the fingerprint. In yet another aspect, the biometric sensor of the disclosure further comprises a database of stored fingerprint patterns against which the most recently read fingerprint is compared, for the purpose of identifying the present individual or for the purpose of access control.

In another embodiment, the sensor of the disclosure can be used as an area monitoring device. In this embodiment, the force sensor disclosed herein can be used can be used to detect the presence or absence of a force-applying object, such as a person, animal, or vehicle. Moreover, the force sensor of this embodiment can be responsive to forces applied thereto from a distance. For example, detection of certain forces or pressures which can be indicative of the presence of objects and their characteristics, i.e., shape, mass, and the like. In this variation, deviation from an expected shape or mass can be indicated. In addition, the sensors can be fabricated in a manner to distinguish the type of object causing a force to be applied, for example, distinguishing between an animal and a person, or various types of animals, or between a vehicle and a person, or between various types of vehicles. In one aspect, the area monitoring device comprising the disclosed sensor can be used to locate the force applying object within an area demarked by the user.

In another aspect, the area monitoring device of the disclosure is suitable to be placed by various means so as to be unobtrusive, or camouflaged to the casual observer. For example, the area monitoring device of the disclosure can be placed beneath dirt, gravel, or other natural matter to as to hide the sensor. In certain aspects, the area monitoring device of the disclosure further comprises circuitry and electronics to locally store data comprising identity, weight and weight distribution, and time factors related to objects detected by the device. In other aspects, the area monitoring device of the disclosure further comprises circuitry and electronics to transmit data to a central data gathering computer or location for further processing or notifications or alarms. In one aspect, the data transmission is by wireless means. In another aspect, the data transmission is via satellite uplink. In one embodiment, the area monitoring device of the disclosure is useful in border security operations to detect, record, or transmit information concerning the presence or passage of people, animals, or vehicles. In another embodiment, the area monitoring device of the disclosure is useful as a pipeline monitoring device to detect, record, or transmit information concerning the presence or passage of people, animals, or vehicles. In another embodiment, the area monitoring device of the disclosure is useful in military theaters of operation to detect, record, or transmit information concerning the presence or passage of people, animals, or vehicles.

In another embodiment, the sensor of the disclosure is also operable as a strain sensor. In another embodiment, the force sensor of the disclosure can be used as a sensitive balance, or means of determining weight of an object placed upon the membrane. In another embodiment, the force sensor of the disclosure can be used as a temperature sensor, changes in temperature resulting in thermal expansion or contraction of the disclosed membrane of the device and further resulting in the measureable changes in resistivity of the disclosed membrane.

In another embodiment, the sensor of the disclosure can be used as a leak detector for fluids or gases. In the embodiment wherein the force sensor of the disclosure can be used as a leak detector, the polymer composition comprising the disclosed membrane of the device is designed to be selectively swelled upon contact with the fluid or gas to be detected. The dimensional distortion of the membrane results in the measurable change in resistivity.

In yet another embodiment, the sensor of the disclosure can be used to track and report movement or lack thereof by an individual confined to bed or wheelchair. Furthermore, the force sensor of the disclosure can be employed as whole house sensing system, for example, an underlayment beneath carpet, for the purpose of tracking and reporting movement or lack thereof by elderly, disabled individuals, or intruders.

In another embodiment, the force sensor of the disclosure can be used as a pressure sensor to measure differential pressure or to detect changes in differential pressure across the membrane.

In another embodiment, the sensor of the disclosure can be used to detect, analyze, and report transient force or pressure applied to the disclosed membrane of the device, such as a force impinging object that is swept across the surface of the membrane of the device.

In another embodiment, the sensor of the disclosure can provide a two-dimensional or three-dimensional topographic type representation of the sealing force applied by a seal against a sealing surface. In a further aspect, the information derived from the sensor is useful to suggest design changes to the seal, to the housing comprising the seal, or to the means of activating, engaging, or setting the seal. The disclosed systems and methods are also useful for verification of proper seal engagement. The seal can comprise a metallic composition of any suitable architecture or design. The seal can alternatively comprise a non-metallic composition of any suitable architecture or design. Seal designs for which the disclosed system is suitable include but are not limited to O-ring seals, D-seals, T-seals, V-seals, X-seals, flat seals, lip seals, back-up rings, bonded seals, annular blow-out-preventors, ram type blow-out-preventors, bridge plugs, and packers. The seal can be mechanically or hydraulically activated, engaged, or set so as to be made to impinge upon a sealing surface. In certain embodiments the non-metallic seal comprises a polymer or mixture of more than one polymer. Many different polymer compositions are known in the art for use in seals, and the disclosed systems and methods are suitable for use with them. In one embodiment, the non-metallic composition comprises an elastomer.

In one embodiment, the seal comprises a packer element, said packer element being disposed circumferentially about a tubular member, together comprising a packer. In other embodiments, the seal comprises multiple packer elements disposed in proximity to one another and further disposed circumferentially about a tubular member, together comprising a packer. The packer can be designed to be tension set, compression set, hydraulic set, or other suitable means of set known in the art, wherein the term “set” indicates a means for causing deformation of the packer element or elements in such as way as to extend the material comprising the element or elements in a radial direction, thereby increasing the outer diameter of the element or elements and causing the element or elements to contact a sealing surface. The packer can be a swellable packer, an inflatable packer, or an expandable packer. The packer can be permanent or retrievable. Numerous packer and packer element designs are known in the art, and the systems, sensors, and methods disclosed herein are useful for measuring the sealing force applied thereby. Examples of suitable packer and packer element designs include, but are not limited to, those disclosed in U.S. Pat. No. 7,696,275; WO 2008/109693; US 2005/0161212; U.S. Pat. No. 7,363,970; U.S. Pat. No. 7,331,581 each of which is included herein by reference in its entirety. In an embodiment wherein the seal is a swellable packer, the system of the disclosure is useful to determine a ‘swell curve’, wherein swelling of the packer element over time is tracked via the force applied by the element or elements against the sealing surface.

In other embodiments, the seal comprises a seal employed in the aerospace industry, such as, for example, seals in hydraulic or fuel systems. The disclosure is similarly useful for measuring the sealing force applied thereby.

In other embodiments, the seal comprises a seal employed in the automotive industry, such as, for example, seals in hydraulic or fuel systems. The disclosure is similarly useful for measuring the sealing force applied thereby.

The sensor of the disclosure is disposed in such a way that the seal, when activated, engaged, set, or swollen, thereby impinges upon the sensor in such as way as to apply a force to the sensor. In certain embodiments, the sensor is disposed in proximity to or adjacent to the sealing surface. In certain embodiments, the sealing surface comprises the outer wall of a housing or apparatus surrounding the seal, as in a pressure testing apparatus such as may be used to determine the proper function and temperature and differential pressure capability of the seal. In other embodiments, the sealing surface comprises casing, or the wall of an open-hole wellbore. In the embodiments wherein the sensor is disposed proximal to the sealing surface, the sensor can be adhered to the sealing surface or outer wall of the housing surrounding the seal by any suitable means, such as by a chemical adhesive or physical means. In other embodiments, the sensor of the disclosure is disposed in proximity to or adjacent to the seal itself. In these embodiments, the sensor can be adhered to the seal by means of chemical adhesive, co-molding, physical attachment, or other suitable means. Whether proximal to the sealing surface or the seal itself, the sensor is disposed in such a way that the seal, when activated, engaged, set, or swollen, impinges upon the sensor in such a way as to apply a force to the sensor.

As such, the present disclosure relates to a method for detecting an applied force comprising determining the change in resistivity of a sensor as disclosed herein. As stated herein above, resistivity is an intrinsic property of the disclosed piezoresistive compositions. The resistivity is affect by a number of factors, for example, the density of the conductive elements within the polymer composite, the type of conductive elements, the shape of the conductive elements, and the like. Therefore, as the piezoresistive compositions which comprise the sensors expands or contracts due to a force, the bulk properties of the compositions will be affected, i.e., the resistivity.

Resistance, current and voltage (potential difference) are all related through Ohm's Law. The change in resistivity of the disclosed piezoelectric compositions due to applied forces can be measured by the user as a change in resistance to current flow, change in resulting voltage or as a change in resistance.

In one embodiment of the disclosed methods of using the disclosed sensors, the change in resistance is utilized as an indication that a force has been applied to the sensor. This method for detecting an applied force comprises:
A) positioning a sensor at a location wherein a force is to be detected, the sensor comprising:
   a) a piezoresistive composition, comprising:
      i) one or more polymers; and
      ii) one or more types of conductive elements dispersed therein; and
   b) at least two electrodes in electrical communication with the composition;
B) passing an electrical current between the at least two electrodes and measuring the initial electrical resistance; and
C) detecting a change in the electrical resistance between the at least two electrodes when a force is applied.

In another embodiment, the change in current flow is utilized to determine that a force has been applied to the sensor. This method for detecting an applied force comprises:
A) positioning a sensor at a location wherein a force is to be detected, the sensor comprising:
   a) a piezoresistive composition, comprising:
      i) one or more polymers; and
      ii) one or more types of conductive elements dispersed therein; and
   b) at least two electrodes in electrical communication with the composition;
B) passing an electrical current between the at least two electrodes and measuring the amount of current; and
C) detecting a change in the amount of current between the at least two electrodes when a force is applied.

In another embodiment, the change in voltage or potential difference is utilized to determine that a force has been applied to the sensor. This method for detecting an applied force comprises:
A) positioning a sensor at a location wherein a force is to be detected, the sensor comprising:
   a) a piezoresistive composition, comprising:
      i) one or more polymers; and
      ii) one or more types of conductive elements dispersed therein; and
   b) at least two electrodes in electrical communication with the composition;
B) applying a voltage between the at least two electrodes and measuring the potential difference; and
C) detecting a change in the potential difference between the at least two electrodes when a force is applied.

### Example 1

A piezoresistive composition was prepared by dispersing a mixture of multi-wall carbon nanotubes and carbon black into a Hydrogenated Nitrile Butadiene Rubber (HNBR) polymer host. A first mixture was created by dissolving 15 g of HNBR polymer in 450 mL of acetone. Meanwhile, a second mixture was created by adding 1.50 g multi-wall carbon nanotubes and 1.20 g carbon black as dry powders to a solution of 1.25 g of the same HNBR polymer dissolved in of 450 mL acetone and 50 mL heptane. This second mixture was energized via high shear mixing for a total of 1 hr, then treated with 20 kHz ultrasound for 0.5 hr. The second mixture was then combined with the first mixture, and 2,5-bis-tert-butylperoxy-2,5-dimethyl hexane was added. The mixture was stirred for 0.5 hr, and the and carbon black were added thereto as dry powders, in an amount such that the total weight solvent was removed under vacuum. The resulting material was first milled on a two roll mill, then compression molded into a membrane of approximately 6″×6″×0.02″ thick. One surface of the resulting membrane had a surface roughness of approximately 25 nm as measured by tapping mode atomic force microscopy. The membrane was placed on top of an electrode array smooth side down, and force was applied as depicted in FIG. 3. A variable force was applied normal to the membrane surface. The resulting change in resistance as a function of applied force was measured utilizing an apparatus such as is depicted in FIG. 1; these data are shown in FIG. 7.

### Example 2

An apparatus was assembled as depicted in FIG. 13. A first electrode 1305 configured as a copper ring having an outside diameter of 2.54 mm and an inside diameter of 15.5 mm was provided as a sealing surface upon which an expanding seal impinges when a force is applied. A second electrode 1302 that was a copper sheet of 0.4 mm thickness was disposed between seal 1301 comprising a fluoroelastomer, and a piezoresistive composition 1303 according to the disclosure comprising hydrogenated nitrile butadiene rubber (HNBR) having conductive elements dispersed therein and being approximately 0.6 mm thickness. The apparatus was assembled in such a manner that an annulus 1304 was formed. Electrode 1302 provides opening 1306 and is thereby not continuous and is capable of expanding due to an applied force. A compressive force was applied perpendicular to the top surface of seal 1301 causing a lateral deflection, thereby causing the seal 1301 to impinge upon the piezoresistive composition 1303 and the first electrode 1305, closing off the annulus 1304. The electrical resistance of the piezoresistive composition was measured as the seal contacted and exerted force thereto. The results are shown in FIG. 12. The change that is observed in the electrical properties of the piezoresistive composition indicates that engagement of the seal against the sealing surface has occurred.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A piezoresistive composition, comprising:
i) one or more polymers; and
ii) one or more types of conductive elements dispersed therein.

2. The composition according to claim 1, wherein the one or more polymers are chosen from thermoplastic, elastomeric, thermoplastic elastomeric, or thermoset polymers.

3. The composition according to claim 1, wherein the conductive elements are chosen from carbon nanotubes, carbon nanosprings, carbon black, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers, or mixture thereof.

4. The composition according to claim 1, wherein the conductive element is carbon black.

5. The composition according to claim 1, wherein the carbon black has a BET surface area of at least about 40 m²/g.

6. The composition according to claim 1, wherein the conductive element is carbon nanotubes.

7. The composition according to claim 1, comprising a plurality of conductive element types chosen from carbon nanotubes, carbon nanosprings, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers, nickel coated graphite, or silver nanorods or flakes.

8. The composition according to claim 7, wherein at least two of the conductive element types has a different geometrical shape.

9. The composition according to claim 7, wherein at least one of the conductive element types has a tube-like geometry and one has a spherical-like geometry.

10. The composition according to claim 1, wherein when the composition is acted upon by a force, the electrical resistivity of the composition changes by at least about one order of magnitude.

11. The composition according to claim 1, wherein when the composition is acted upon by a force of from about 0.1 N to about 500 N, the electrical resistivity of the composition changes by at least about two orders of magnitude.

12. The composition according to claim 1, wherein when the composition is acted upon by a force of greater than about 500 N, the electrical resistivity of the composition changes by at least about three orders of magnitude.

13. The composition according to claim 1, wherein when the composition is acted upon by a force and the force subsequently removed, the composition will have a recovered resistivity of at least about 60% of the initial resistivity.

14. The composition according to claim 1, wherein at least one of the conductive element types has at least one dimension that is less than about 110 nm.

15. A sensor for detecting an applied force, comprising:
a) a piezoresistive composition, comprising:
i) one or more polymers; and
ii) one or more types of conductive elements dispersed therein; and
b) at least two electrodes in electrical communication with the composition.

16. The sensor according to claim 15, wherein the sensor quantitatively measures force applied thereto.

17. The sensor according to claim 15, wherein the sensor is capable of locating the position at which force is applied thereto.

18. The sensor according to claim 15, wherein the sensor is capable of detecting, locating the position of, and differentiating between a plurality of forces applied thereto.

19. The sensor according to claim 15, wherein the one or more polymers are chosen from thermoplastic, elastomeric, thermoplastic elastomeric, or thermoset polymers.

20. The sensor according to claim 15, wherein the one or more conductive element types are chosen from carbon nanotubes, carbon nanosprings, carbon black, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers.

21. The sensor according to claim 15, wherein the conductive element is carbon black.

22. The sensor according to claim 21 wherein the carbon black has a BET surface area of at least about 40 m²/g.

23. The sensor according to claim 15, wherein the conductive element is carbon nanotubes.

24. The sensor according to claim 15, comprising a plurality of conductive element types chosen from carbon nanotubes, carbon nanosprings, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers, nickel coated graphite, or silver nanorods or flakes.

25. The sensor according to claim 24, wherein at least two of the conductive element types has a different geometrical shape.

26. The sensor according to claim 24, wherein at least one of the conductive element types has a tube-like geometry and one has a spherical-like geometry.

27. The sensor according to claim 15, wherein when the piezoresistive composition is acted upon by a force of from about 0.1 N to about 500 N, the electrical resistivity of the composition changes by at least about two orders of magnitude.

28. The sensor according to claim 15, wherein when the piezoresistive composition is acted upon by a force of greater than about 500 N, the electrical resistivity of the composition changes by at least about three orders of magnitude.

29. The sensor according to claim 15, wherein the at least two electrodes are Schottky diodes.

30. The sensor according to claim 15, comprising four or more electrodes.

31. A method for detecting an applied force, comprising determining the change in resistivity of a sensor according to claim 1.

32. A method for detecting an applied force, the method comprising:
A) positioning a sensor at a location wherein a force is to be detected, the sensor comprising:
a) a piezoresistive composition, comprising:
i) one or more polymers; and
ii) one or more types of conductive elements dispersed therein; and
b) at least two electrodes in electrical communication with the composition;
B) passing an electrical current between the at least two electrodes and measuring the initial electrical resistance; and
C) detecting a change in the electrical resistance between the at least two electrodes when a force is applied.

33. The method according to claim 32, wherein the change in electrical resistance is used quantify the force that is detected.

34. A method for detecting an applied force, the method comprising:
A) positioning a sensor at a location wherein a force is to be detected, the sensor comprising:
a) a piezoresistive composition, comprising:
i) one or more polymers; and
ii) one or more types of conductive elements dispersed therein; and
b) at least two electrodes in electrical communication with the composition;
B) passing an electrical current between the at least two electrodes and measuring the amount of current; and
C) detecting a change in the amount of current between the at least two electrodes when a force is applied.

35. The method according to claim 34, wherein the change in electrical resistance is used quantify the force that is detected.

36. A method for detecting an applied force, the method comprising:
A) positioning a sensor at a location wherein a force is to be detected, the sensor comprising:
a) a piezoresistive composition, comprising:
i) one or more polymers; and
ii) one or more types of conductive elements dispersed therein; and
b) at least two electrodes in electrical communication with the composition;
B) applying a voltage between the at least two electrodes and measuring the potential difference; and
C) detecting a change in the potential difference between the at least two electrodes when a force is applied.

38. The method according to claim 36, wherein the change in electrical resistance is used quantify the force that is detected.
